(19) United States
(12) Patent Application Publication
(10) Pub. No.: US 2025/0080626 A1
(43) Pub. Date: Mar. 6, 2025

(54) PROTOCOL TRANSLATION FOR BUILDING-EDGE WIRELESS ACCESS POINT

(71) Applicant: T-Mobile USA, Inc., Bellevue, WA (US)

(72) Inventors: Relin Thomas, Bothell, WA (US); Egil Gronstad, Encinitas, CA (US); Jun Liu, Issaquah, WA (US)

(21) Appl. No.: 18/459,875

(22) Filed: Sep. 1, 2023

(51) Int. Cl. H04L 69/08

(52) U.S. Cl. CPC H04L 69/08

(57) ABSTRACT

A wireless access point described herein includes an outside part and an inside part attached on opposite sides of a building's window. The outside part transmits to and receives from one or more access points of a telecommunications network over licensed radio frequencies, first unlicensed radio frequencies, or both. The inside part transmits to and receives from one or more devices disposed within the building using second unlicensed radio frequencies, another wireless communication mechanism, or both. Either or both of the outside part or the inside part include translation logic configured to translate between a first protocol representing an inbound communication and a second protocol representing an outbound communication.

### BACKGROUND

Customer premises equipment (CPE), such as in home routers and cable set-top boxes, their commercial equivalents, and wireless access points installed outside but on or adjacent to a home or office, face challenges. In home CPEs connecting over cable or fiberoptic wired systems transmit data in a password protected manner but otherwise lack additional security. Such cable-or fiberoptic-using CPEs also face hurdles for upgrades as replacing a cable or wire throughout a home and yard may involve extensive work. CPEs connecting to base stations outside of the home or office are often installed external to the premises and may require additional wiring. Such installations may be beyond the ability of a typical home or business owner. Further, transmission over radio frequencies through walls of a building can result in reduced quality of user experience due to interference from those structures. Further, repeaters that can extend radio frequency coverage require support for the same broadcast bands as received bands despite lack of use of many such bands by in-premises devices, resulting in needlessly expensive and complex equipment.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram of a building with a multipart wireless access point affixed to its window, with an outside part of the wireless access point communicating with an access point of a telecommunications network over cellular radio frequenc(ies) and an inside part communicating with in-building device(s) over an unlicensed frequencies and/or other communication mechanism(s), and with the wireless access point translating between protocols associated with inbound and outbound communications.

FIG. 2 is a schematic diagram of an example system architecture of a multipart wireless access point with a part inside a building and a part outside of the building, both attached to a window of the building opposite each other.

FIG. 3 is a diagram of translation logic of the multipart wireless access point, showing inbound and outbound communications, protocol stacks or data representations associated with protocols of the communications, and the translation logic as an intermediary between the protocol stacks/data representations.

FIG. 4 is a flow diagram of an illustrative process for translating an inbound communication from a first protocol of cellular or Wi-Fi radio frequency technologies to a second protocol to generate an outbound communication associated with the second protocol.

### DETAILED DESCRIPTION

This disclosure is directed in part to a wireless access point that includes a first part, such as an outside part, and a second part, such as an inside part, attached on opposite sides of a building's window. The wireless access point may be a CPE for the building, which may be a home, office, store, or other type of structure. The outside part transmits and receives over radio frequenc(ies) of an access point of a telecommunications network, such as licensed radio frequenc(ies), first unlicensed radio frequenc(ies), or both. The inside part of the wireless access point transmits and receives over second unlicensed radio frequenc(ies) and/or other communication mechanism(s) to one or more devices in the building. The wireless access point further includes translation logic to translate between a first protocol representing an inbound communication and a second protocol representing an outbound communication.

In various implementations, the first protocol or the second protocol may be associated with at least one of the licensed radio frequencies and is one of a new radio (NR) protocol, a long term volution (LTE) protocol, a third generation (3G) protocol, a second generation (2G) protocol, or a protocol associated with citizen broadband radio service (CBRS). The first protocol or the second protocol may be associated with at least one of unlicensed radio frequency of the first unlicensed radio frequencies or the second unlicensed radio frequencies and is one of a protocol associated with a Wi-Fi radio frequency or with a Bluetooth radio frequency. Further, the first protocol or second protocol may include a data representation, such as a data representation of data from or for infrared communication or wired (e.g., Ethernet) communication. Also, the first unlicensed radio frequenc(ies) and the second unlicensed radio frequenc(ies) may include a same range of radio frequenc(ies), an overlapping range of radio frequenc(ies), or different radio frequenc(ies).

In further implementations, the terms “first protocol” and “second protocol” may include a data format, such as a data format represented by a protocol stack, or another data representation for other data, such as data received from infrared or wired communication mechanisms. The translation logic may receive the inbound communication from a first protocol stack a first data representation and transmit the outbound communication to a second protocol stack or a second data representation. In some implementations, the translation logic may generate an intermediate representation from the inbound communication and may use the intermediate representation to generate the outbound communication as one or more transmissions using at least the second protocol. Further, in additional implementations, the translation logic may generate the outbound communication as multiple transmissions, each to a different endpoint and at least two of the multiple transmissions using different radio frequencies or using a radio frequency and the other communication mechanism.

In some implementations, the wireless access point selects among licensed radio frequencies, among first unlicensed radio frequencies, or among both for the outbound communication based on power resources of the wireless access point. For example, the wireless access point may seek to minimize/optimize the power resources by, e.g., selecting radio frequencies/communication mechanisms so as to maximize battery life. These selected radio frequencies/communication mechanisms could then be indicated to the translation logic (or determined by it) for use in determining the protocol stack(s) or data representations to be used for the outbound communication.

In further examples, the wireless access point and the one or more access points are associated with a mobile network operator and at least one of the one or more devices disposed within the building is not a subscriber of the mobile network operator. This enables a subscriber associated with the wireless access point to provide mobile network operator coverage to those inside the building whether they are mobile network operator subscribers or not.

Additionally, the wireless access point may receive and implement an update to the translation logic. The update may support translation to and from an additional protocol and may thus add support for a protocol stack or a data representation.

In various implementations, both the inside part and the outside part may be affixed to the window by adhesive mechanisms. In some implementations, the inside part and outside part may communicate between each other using one of light emitting and detecting components, laser emitting and detecting components, or components for impedance matching. Such components may be integrated into the inside part and the outside part of the wireless access point.

In further implementations, the inside part of the wireless access point may receive a charge through a charging port of the inside part and transmit the charge through the window to the outside part of the wireless access point. The charge may be provided by a battery integrated into the inside part, by a charging cord plugged into an electrical socket, by a cable plugged into another electronic device, or by inductive charge through an inductive charger placed against an outer surface of the inside part. If the charge is provided by a battery, the battery may be rechargeable.

The wireless access point may also include an Ethernet port (e.g., on the inside part) or a subscriber identity module (SIM) or embedded SIM (eSIM) (integrated in the inside part or the outside part). The Ethernet port may be disposed on a surface of the inside part for wireline communications with a device inside the building. The SIM or eSIM may be configured to provide identity information for the wireless access point to the telecommunications network.

In some implementations, the device inside the building may be one of a plurality of devices communicating through the wireless access point to the telecommunications network. In such examples, the wireless access point may be configured to prioritize transmissions to or from different ones of the devices based on device types associated with the devices or content types associated with the transmissions. The plurality of devices in such examples may include a security camera, an Internet-of-Things device, a media player, a computing device, or a user equipment (UE).

In various implements, the wireless access point may be managed by an application of a UE. The application may provide set-up guidance for installing the wireless access point. The set-up guidance may include capabilities for identifying signal strengths at possible installation sites around the building. The application may also include capabilities for determining whether a window is suitable for installation.

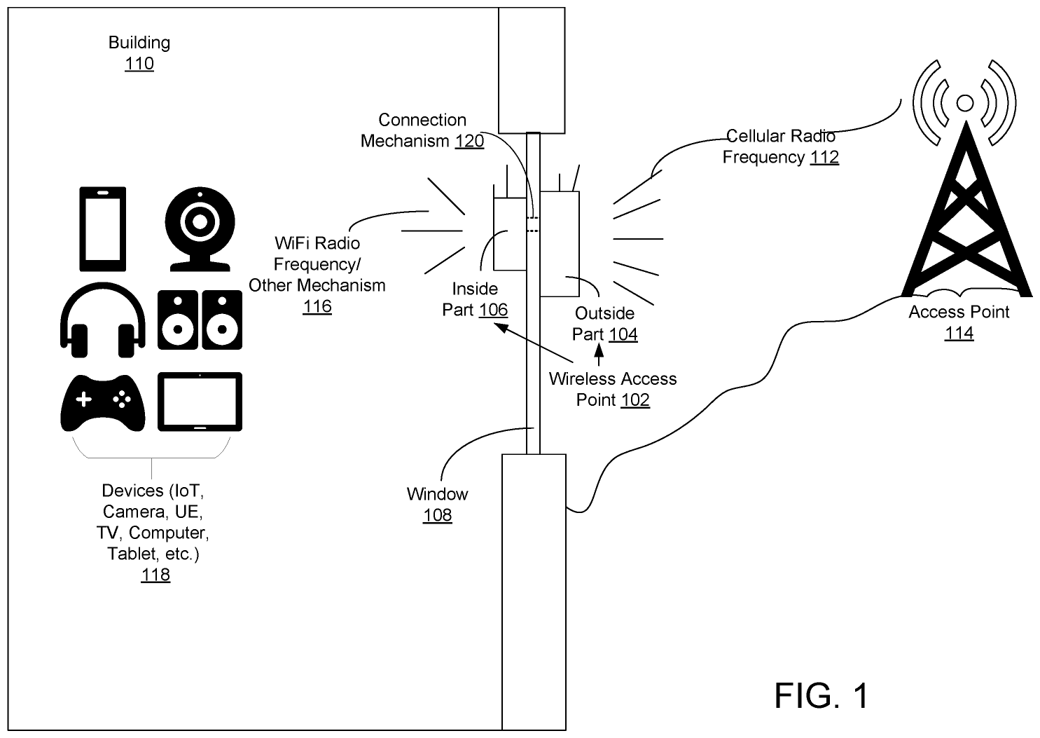

FIG. 1 is a diagram of a building with a multipart wireless access point affixed to its window, with an outside part of the wireless access point communicating with an access point of a telecommunications network over cellular radio frequenc(ies) and an inside part communicating with in-building device(s) over an unlicensed frequencies and/or other communication mechanism(s), and with the wireless access point translating between protocols associated with inbound and outbound communications. As illustrated, a wireless access point 102 is comprised on an outside part 104 and an inside part 106, each attached to a window 108 of a building 110 opposite of the other. The inside part 106 is inside the building 110; the outside part 104 is outside of the building 110. The outside part 104 sends and receives over a cellular radio frequency 112 to/from an access point 114 of a telecommunications network. The inside part 106 sends and receives over a Wi-Fi radio frequency 116/other communication mechanism 116 to/from one or more devices 118 disposed inside the building 110. Also illustrated, the connection mechanism 120 may be light/laser components integrated into each of the inside part 106 and outside part 104 enabling communication through the window 108.

In various implementations, the building 110 may be any sort of structure, such as a house, an out-building of a house (e.g., garage, guest quarters, etc.), a store, a factory, an office building, etc. The building 110 may have at least one window 108 and be within range of an access point 114 or repeater or relay device extending a range of the access point 114. The window 108 may be on a ground-level, a second floor, or some higher floor/level of building 110. The window 108 may be double-pained, single-pained, or any other type of window. As noted above, the wireless access point 102 may serve as or in place of CPE for the building 110, replacing such devices as set-top boxes, media consoles, routers, access points, satellites, external CPEs, repeaters, etc.

In some implementations, the access point 114 of the telecommunications network may be any sort of base station or wireless access point connected to other devices of the telecommunications network via, e.g., wired or wireless backhaul. The access point 114 may represent a single device or multiple devices (e.g., a base station and relay/extender/repeater, a macrocell device and a femtocell device, etc.). It may include one or more antennae for radio frequency communications over, e.g., cellular radio frequency 112. Further, the point 114 may be of any generation of technology (e.g., Third access Generation (3G), Fourth Generation (4G), Fifth Generation (5G), Sixth Generation (6G), or later generation) and may be, for instance, an eNode B (eNB) or a gNode B (gNB).

As shown in FIG. 1, devices 118 may be disposed inside of the building 110. The devices 118 inside of the building 110 may be in any locations within the building 110 and may each communicate over an Wi-Fi radio frequency 116, such as a Wi-Fi/802.11 frequency or a Bluetooth frequency, or another communication mechanism, such as infrared communication or a wire (e.g., Ethernet). Any unlicensed frequency or other communication mechanism, however, may be used as Wi-Fi radio frequency/other communication mechanism 116. In some implementations, the inside part 106 may be configured to transmit on multiple Wi-Fi radio frequencies/other communication mechanism(s) 116 at a same time or at different times (e.g., transmit a same outbound communication or multiple outbound communications concurrently).

The devices 118 may include a security camera, an Internet-of-Things device, a media player, a television (TV), speakers, headphones, a gaming device, a tablet computer, a computing device, or a UE. In some examples, they may communicate with the inside part 106 over the Wi-Fi radio frequency/other communication mechanism 116 though one or more repeater/relay devices disposed in the building 110.

In various implementations, the inside part 106 and outside part 104 are each affixed to the window 108 using, e.g., an adhesive mechanism. The inside part 106 and outside part 104 are positioned opposite each other in a particular alignment to enable the connection mechanism 120 to communicate via light/laser (or, alternatively, impedance matching) and to allow charge to be conveyed from the inside part 106 to the outside part 104 though the window 108. Each of the inside part 106 and outside part 104 may be of any size, so long as not too large for the window 108, and need not be the same size as each other. Each of the inside part 106 and outside part 104 may have external antennae (or not), input/output devices (or not), and, on a window-facing surface, components for emitting/detecting light/laser (or, alternatively, for performing impedance matching) and for conveying charge. The inside part 106 may also include one or more external ports, such as an Ethernet port, a charge port, a peripheral device jack/port, etc. In some examples, the inside part 106 may also include a removable, rechargeable battery or disposable batteries.

In some implementations, the outside part 104 communicates with the access point 114 over cellular radio frequency 112. The cellular radio frequency 112 may be any sort of frequency band, such as licensed, unlicensed, CBRS, etc. utilized by a mobile network operator, and many include an aggregation of such bands. In one embodiment, cellular radio frequency 112 may on some occasions be a same radio frequency, same radio frequency range, or overlapping radio frequency range as Wi-Fi radio frequency 116. The outside part 104 however, may be configured to communicate over a range of cellular radio frequencies 112 of multiple types. In some examples, the outside part 104 may be capable of communicating via carrier aggregation, etc.

As described herein, the inside part 106 may communicate with devices 118 over a Wi-Fi radio frequency 116, which may include any unlicensed radio frequency, such as Wi-Fi or Bluetooth. The inside part 106 may send and receive over that frequency. Also, the inside part 106 may include other communication mechanisms 116, such as Ethernet port(s) and other wired jacks/ports to support wired communication between the inside part 106 and the devices 118. Other communication mechanisms 116 may also include components for emitting and receiving infrared waves.

While devices 118 communicate with inside part 106, inside part 104 with outside part 104, and outside part 104 with the access point 114, the ultimate endpoints of such communications may be the devices 118 and other devices accessible through or part of the telecommunications network. The telecommunications network may give different priorities to different types of the devices 118 or different types of content of the devices 118, and the inside part 106, outside part 104, or both may utilize those priorities in the manner that data transmissions are prioritized within the wireless access point 102 and in transmissions sent for it.

In various implementations, a translation logic may be implemented in the outside part 104, inside part 106, or both may and may translate between a protocol of the inbound one of the Wi-Fi radio frequency 116/other communication mechanism 116 and cellular radio frequency 112 and a protocol of the outbound other of the Wi-Fi radio frequency 116/other communication mechanism 116 and cellular radio frequency 112. Further, when the outbound communication is to be sent over the cellular radio frequency 112, it may be secured across multiple layers of a network stack, such as a physical layer, a link layer, a network layer, an application layer, etc. Such securing effectively places the transmission within a firewall of the telecommunications network.

In various implementations, transmissions sent for the outside part 104 may also include credentials from a SIM or eSIM, which may be located in the outside part 104, inside part 106, or partially in each. Such credentials may be retrieved and included in the transmission before it is sent to the access point 114.

Communication through the window 108 relies on light emission and detection or laser emission and detection for ultrafast data transmission. Alternatively, communication through the window 108 may rely on impedance matching. The light or laser and the components creating and recording them (or such components for impedance matching) may constitute the connection mechanism 120 shown in FIG. 1. No part of the intervening window 108 needs be modified, removed, replaced, etc.

In some implementations, the charge may also be conveyed through the window 108 without any modifications to the window 108. The charge may be received at the inside part 106, conveyed by the inside part 106 through the window 108 to the outside part 104 and used, stored, or both by the outside part 104. The source of the charge received by the inside part 106 may be batteries (as described further herein), a charge cord, inductive charge, etc.

In various implementations, the wireless access point 102 may be the hub or router device of a security service, e.g., a home security service, of a home appliance management service, etc.

Setting up the wireless access point 102 may be achieved through an application downloaded on a UE or computer or through a website, with the application or website providing instructions for attaching the outside part 104 and inside part 106. The application or website may also help identify an optimal window location based on, e.g., signal strength of the access point 114, number of devices 118 that can be detected at once, or a combination of such factors. In some implementations, the application or website may also determine if a window is suitable based on its clarity/window type. In further implementations, the application or website may also be used for managing the wireless access point 102, managing settings and other aspects of the device.

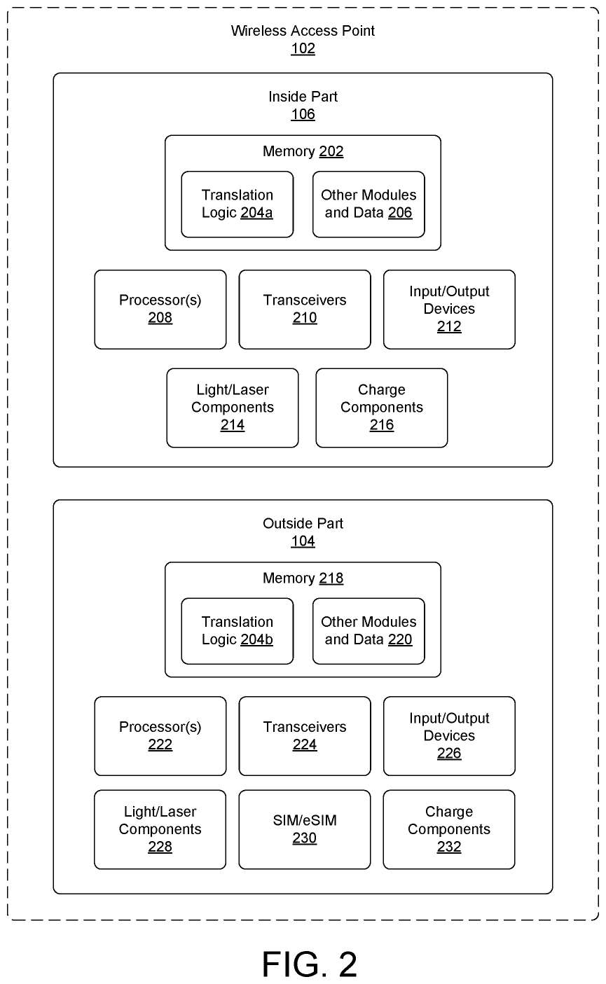

FIG. 2 is a schematic diagram of an example system architecture of a multipart wireless access point with a part inside a building and a part outside of the building, both attached to a window of the building opposite each other. The wireless access point 102 is shown as a dotted line box comprising the inside part 106 and outside part 104. This is because the wireless access point 102 is the combination of the inside part 106 and outside part 104; that is, it is a logical representation of the two of those parts as a single operating unit. As shown, the inside part 106 includes a memory 202 storing translation logic 204a, modules and data 206, as well as processor(s) 208, transceivers 210, input/output devices 212, light/laser components 214, and charge components 216. The outside part 104 includes a memory 218 storing translation logic 204b and other modules and data 220. The outside part 104 also includes processor(s) 222, transceivers 224, input/output devices 226, light/laser components 228, SIM/eSIM 230, and charge components 232.

In various examples, the memory 202 can include system memory, which may be volatile (such as RAM), non-volatile (such as ROM, flash memory, etc.) or some combination of the two. The memory 202 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the inside part 106 of the wireless access point 102. Any such non-transitory computer-readable media may be part of the inside part 106 of the wireless access point 102.

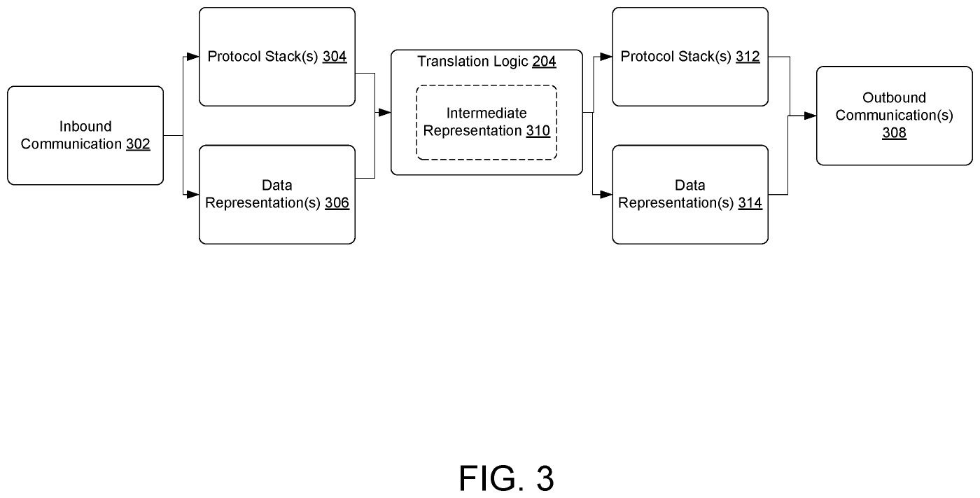

The memory 202 can include one or more software or firmware elements, such as computer-readable instructions that are executable by the one or more processors 208. For example, the memory 202 can store computer-executable instructions associated with translation logic 204a modules and data 206. Translation logic 204 may be present in the inside part 106 as translation logic 204a, may be present in the outside part 104 as translation logic 204b, or may be present in both. The translation logic 204 is shown in FIG. 3 and described herein in further detail with reference to that figure. The modules and data 206 can include a platform, operating system, and applications, and data utilized by the platform, operating system, and applications. Further, the modules and data 206 can implement any of the functionality for the inside part 106 described and illustrated herein. In some examples, the modules and data 206 may also implement some or all of the functionality described for the outside part 104. In some implementations, the other modules and data 206 can include logic for determining power available via charge components 216 (e.g., a battery level, when charge components 216 are/include a battery), selecting radio frequenc(ies) and/or communication components for outbound transmission so as to minimize/optimize power usage, and indicating the selection to the translation logic 204 to enable it to utilize corresponding protocol stacks and/or data representations for generating the outbound communication.

In various examples, the processor(s) 208 can be a CPU, a graphics processing unit (GPU), or both CPU and GPU, or any other type of processing unit. Each of the one or more processor(s) 208 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 208 may also be responsible for executing all computer applications stored in the memory 202, which can be associated with types of volatile (RAM) and/or nonvolatile (ROM) memory.

The transceivers 210 can include modems, interfaces, antennas, Ethernet ports, cable interface components, infrared transceivers, and/or other components that perform or assist in exchanging wireless communications, wired communications, or both.

While the inside part need not include input/output devices 212, in some implementations it may include one, some, or all of these. For example, the input/output devices 212 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 212 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 212 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

In various implementations, the inside part 106 includes light/laser components 214, such as light/laser emitting components and light/laser detecting components disposed on a window-facing surface of the inside part 106 to communicate data with the outside part 104 through the window. The light/laser components 214 may also be representative of impedance matching components.

In some implementations, the charge components 216 may include a battery, rechargeable or single charge, integrated into or attached to the inside part 106. Alternatively or additionally, the charge components 216 may include a port for a charging cord plugged into an electrical socket, a port for a cable plugged into another electronic device, or a surface for receiving inductive charge through an inductive charger placed against that surface. The charge components 216 may also include window-facing components for conveying charge through the window to the outside part 104.

In various examples, the memory 218 can include system memory, which may be volatile (such as RAM), non-volatile (such as ROM, flash memory, etc.) or some combination of the two. The memory 218 can further include non-transitory computer-readable media, such as volatile and nonvolatile, removable and non-removable media implemented in any method or technology for storage of information, such as computer readable instructions, data structures, program modules, or other data.

System memory, removable storage, and non-removable storage are all examples of non-transitory computer-readable media. Examples of non-transitory computer-readable media include, but are not limited to, RAM, ROM, EEPROM, flash memory or other memory technology, CD-ROM, DVD or other optical storage, magnetic cassettes, magnetic tape, magnetic disk storage or other magnetic storage devices, or any other non-transitory medium which can be used to store the desired information and which can be accessed by the outside part 104 of the wireless access point 102. Any such non-transitory computer-readable media may be part of the outside part 104 of the wireless access point 102.

The memory 218 can include one or more software or firmware elements, such as computer-readable instructions that are executable by the one or more processors 222. For example, the memory 218 can store computer-executable instructions associated with the translation logic 204b or the other modules and data 220. As noted above, translation logic 204 may be present in the inside part 106 as translation logic 204a, may be present in the outside part 104 as translation logic 204b, or may be present in both. The translation logic 204 is shown in FIG. 3 and described herein in further detail with reference to that figure. The other modules and data 220 can include a platform, operating system, and applications, and data utilized by the platform, operating system, and applications. Further, the other modules and data 220 can implement any of the functionality for the outside part 104 described and illustrated herein. In some examples, the other modules and data 220 may also implement some or all of the functionality described for the inside part 106. In some implementations, the other modules and data 220 can include logic for determining power available via charge components 232 (e.g., a battery level, when charge components 232 are/include a battery), selecting radio frequenc(ies) and/or communication components for outbound transmission so as to minimize/optimize power usage, and indicating the selection to the translation logic 204 to enable it to utilize corresponding protocol stacks and/or data representations for generating the outbound communication.

In various examples, the processor(s) 222 can be a CPU, a GPU, or both CPU and GPU, or any other type of processing unit. Each of the one or more processor(s) 222 may have numerous ALUs that perform arithmetic and logical operations, as well as one or more CUs that extract instructions and stored content from processor cache memory, and then executes these instructions by calling on the ALUs, as necessary, during program execution. The processor(s) 222 may also be responsible for executing all computer applications stored in the memory 218, which can be associated with types of volatile (RAM) and/or nonvolatile (ROM) memory.

The transceivers 224 can include modems, interfaces, antennas, Ethernet ports, cable interface components, infrared transceivers, and/or other components that perform or assist in exchanging wireless communications, wired communications, or both.

While the outside part 104 need not include input/output devices 226, in some implementations it may include one, some, or all of these. For example, the input/output devices 226 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 226 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 226 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

In various implementations, the outside part 104 includes light/laser components 228, such as light/laser emitting components and light/laser detecting components disposed on a window-facing surface of the outside part 104 to communicate data with the inside part 106 through the window. The light/laser components 228 may also be representative of impedance matching components.

In further implementations, the outside part 104 includes a SIM or eSIM 230 which provides credentials for the telecommunications network when the outside part 104 is sending transmissions to the base station. In other implementations, the SIM or eSIM 230 may be placed in the inside part 106 and the credentials may be communicated between the inside part 106 and the outside part 104. Because the wireless access point 102 has a SIM or eSIM 230, the devices 118 connecting to the wireless access point 102 need not be subscribers of the mobile network operator associated with the SIM or eSIM 230 and need not have SIMs or eSIMs themselves.

In some implementations, the charge components 232 may include window-facing components for receiving charge through the window from the inside part 106. The charge components 232 may also include an internal battery for storing the received charge.

FIG. 3 is a diagram of translation logic of the multipart wireless access point, showing inbound and outbound communications, protocol stacks or data representations associated with protocols of the communications, and the translation logic as an intermediary between the protocol stacks/data representations. As illustrated, the wireless access point 102 receives an inbound communication 302. The translation logic 204 translates a representation of the inbound communication 302 from one or more protocol stacks 304 and/or from data representation 306. The translation logic 204 translates the inbound communication directly into the outbound communication 308 or first into an intermediate representation 310. Either one or more protocol stacks 312 or data representation 314 may be data format(s) or type(s) that the inbound communication 302 or intermediate representation 310 is translated into.

In various implementations, the inbound communication 302 is received at one of the outside part 104 or the inside part 106 and the outbound communication 308 is transmitted through the other of the outside part 104 or the inside part 106. The inbound communication 302 and outbound communication 308 may be different representations of the same or similar data, the different representations formatted for different communication mechanisms in accordance with protocols or formats having different protocol stacks 304/312 and/or different data representations 306/314. In some implementations, the inbound communication 302 may be received using carrier aggregation and/or the outbound communication 308 may be transmitted using carrier aggregation, involving. Such transmitting or receiving may involve multiple protocols for multiple network types and multiple corresponding protocol stacks 304/312 or data representations 306/314.

In some examples, the protocol stacks 304/312 include LTE protocol stacks, NR protocol stacks, 3G protocol stacks, 2G protocol stacks, CBRS protocol stacks, etc. for the corresponding protocols. Such protocol stacks 304/312 can comprise multiple layers (e.g., physical, link, network, transport, application, etc.) and may correspond to the Open Systems Interconnect (OSI) model or other framework, or a subset of such a model/framework.

Data representations 306/314 may be any sort of data structure, such as a structure for representing inbound communications 302 or outbound communications 308 for transmitting/receiving using infrared communications or wired communications (e.g., Ethernet).

In various implementations, the translation logic 204 may create an intermediate representation 310 using, e.g., the extensible markup language (XML) or other specification/format not tied to a communication protocol or mechanism. Such an intermediate representation 310 may reduce work for the translation logic 204 when translating from/to multiple protocols/communication formats or when an outbound communication 308 generated from the intermediate representation is to be sent multiple times over a time period.

In further implementations, the translation logic 204 receives an identification of the protocol stack(s) 312 and/or data representation(s) 314 for the outbound communication 308 from another component of the wireless access point 102 or determines the protocol stack(s) 312 and/or data representation(s) 314 through, e.g., communication with interface(s) of the transceiver(s) 210/224. The component which selects the protocol stack(s) 312 and/or data representation(s) 314 for the outbound communication may do so based on a power level (e.g., battery level) of the wireless access point 102 in order to optimize/minimize power usage for the wireless access point 102.

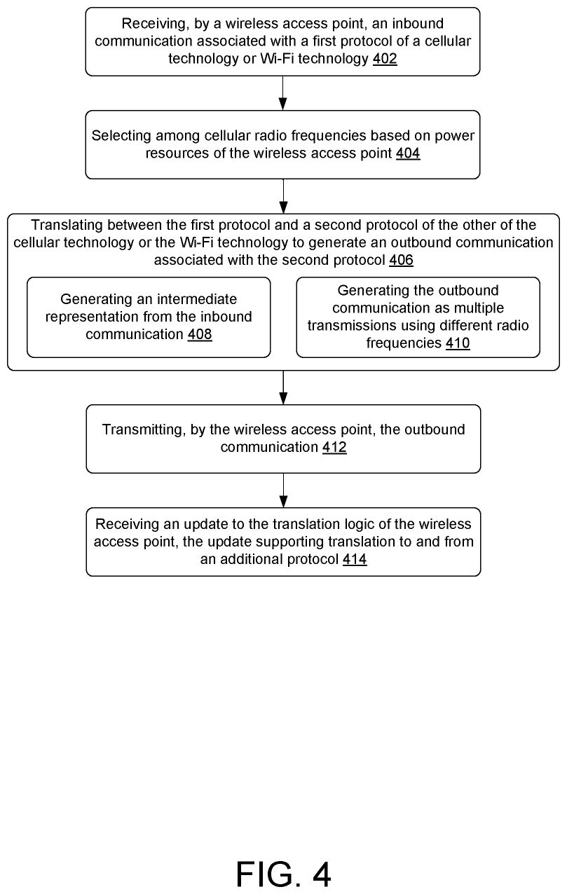

FIG. 4 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 4 is a flow diagram of an illustrative process for translating an inbound communication from a first protocol of cellular or Wi-Fi radio frequency technologies to a second protocol to generate an outbound communication associated with the second protocol. In FIG. 4, at 402, a wireless access point receives an inbound communication associated with a first protocol of one of a cellular radio frequency technology or a Wi-Fi radio frequency technology. In various implementations, the inbound communication is received at a first part of the wireless access point and the outbound communication is transmitted at a second part of the wireless access point. One of the first part and the second part is disposed outside of a building and the other of the first part and the second part is disposed inside of the building, on an opposite side of a window of the building from the first part.

At 404, in some implementations, the wireless access point may select among cellular radio frequencies based on power resources of the wireless access point.

At 406, translation logic of the wireless access point translates between the first protocol and a second protocol of the other of the cellular radio frequency technology or the Wi-Fi radio frequency technology to generate an outbound communication associated with the second protocol. At 408, the translating may comprise generating an intermediate representation from the inbound communication and using the intermediate representation to generate the outbound communication as one or more transmissions using at least the second protocol. At 410, the translating may comprise generating the outbound communication as multiple transmissions, each to a different endpoint and at least two of the multiple transmissions using different radio frequencies. In some implementations, the translation logic may receive the inbound communication from a first protocol stack or a first data representation and transmit the outbound communication to a second protocol stack or a second data representation.

At 412, the wireless access point transmits the outbound communication.

At 414, the wireless access point may receive an update to the translation logic of the wireless access point, the update supporting translation to and from an additional protocol. While the receiving at 414 is shown following 412, the receiving at 414 may occur before, during, or after any of the operations shown at 402-412.

In various implementations, the first protocol or the second protocol may be associated with the cellular radio frequency technology and may be one of NR protocol, a LTE protocol, a 3G protocol, a 2G protocol, or a protocol associated with CBRS.

Further, in some implementations, the wireless access point and the one or more access points are associated with a mobile network operator and at least one of the one or more devices disposed within the building is not a subscriber of the mobile network operator.

Although features and/or methodological acts are described above, it is to be understood that the appended claims are not necessarily limited to those features or acts. Rather, the features and acts described above are disclosed as example forms of implementing the claims.

What is claimed is:

1. A wireless access point, comprising:
a first part disposed outside of a building, the first part transmitting to and receiving from one or more access points of a telecommunications network over licensed radio frequencies, first unlicensed radio frequencies, or both;
a second part disposed inside of the building, on an opposite side of a window of the building from the first part, the second part transmitting to and receiving from one or more devices disposed within the building using second unlicensed radio frequencies, another wireless communication mechanism, or both; and
translation logic disposed in the first part, the second part, or both and configured to translate between a first protocol representing an inbound communication received at one of the first part and the second part and a second protocol representing an outbound communication transmitted through the other of the first part and the second part.

2. The wireless access point of claim 1, wherein the first protocol or the second protocol is associated with at least one of the licensed radio frequencies and is one of a new radio (NR) protocol, a long term volution (LTE) protocol, a third generation (3G) protocol, a second generation (2G) protocol, or a protocol associated with citizen broadband radio service (CBRS).

3. The wireless access point of claim 1, wherein the first unlicensed radio frequencies and the second unlicensed radio frequencies are the same radio frequencies or overlapping radio frequency ranges.

4. The wireless access point of claim 1, wherein the first protocol or the second protocol is associated with at least one of unlicensed radio frequency of the first unlicensed radio frequencies or the second unlicensed radio frequencies and is one of a protocol associated with a Wi-Fi radio frequency or with a Bluetooth radio frequency.

5. The wireless access point of claim 1, wherein the other wireless communication mechanism is infrared communication.

6. The wireless access point of claim 1, wherein the translation logic receives the inbound communication from a first protocol stack or a first data representation and transmits the outbound communication to a second protocol stack or a second data representation.

7. The wireless access point of claim 6, wherein the translation logic is configured to generate an intermediate representation from the inbound communication and use the intermediate representation to generate the outbound communication as one or more transmissions using at least the second protocol.

8. The wireless access point of claim 1, wherein the translation logic is configured to generate the outbound communication as multiple transmissions, each to a different endpoint and at least two of the multiple transmissions using different radio frequencies or using a radio frequency and the other communication mechanism.

9. The wireless access point of claim 1, wherein the wireless access point selects among licensed radio frequencies, among first unlicensed radio frequencies, or among both for the outbound communication based on power resources of the wireless access point.

10. The wireless access point of claim 1, wherein the wireless access point and the one or more access points are associated with a mobile network operator and at least one of the one or more devices disposed within the building is not a subscriber of the mobile network operator.

11. The wireless access point of claim 1, wherein the wireless access point is configured to receive an update to the translation logic, the update supporting translation to and from an additional protocol.

12. A method comprising:
receiving, at a wireless access point, an inbound communication associated with a first protocol of one of a cellular radio frequency technology or a Wi-Fi radio frequency technology;
translating, by translation logic of the wireless access point, between the first protocol and a second protocol of the other of the cellular radio frequency technology or the Wi-Fi radio frequency technology to generate an outbound communication associated with the second protocol; and
transmitting, by the wireless access point, the outbound communication,
wherein the inbound communication is received at a first part of the wireless access point and the outbound communication is transmitted at a second part of the wireless access point, and one of the first part and the second part is disposed outside of a building and the other of the first part and the second part is disposed inside of the building, on an opposite side of a window of the building from the first part.

13. The method of claim 12, wherein the first protocol or the second protocol is associated with the cellular radio frequency technology and is one of a new radio (NR) protocol, a long term volution (LTE) protocol, a third generation (3G) protocol, a second generation (2G) protocol, or a protocol associated with citizen broadband radio service (CBRS).

14. The method of claim 12, wherein the translating comprises generating an intermediate representation from the inbound communication and using the intermediate representation to generate the outbound communication as one or more transmissions using at least the second protocol.

15. The method of claim 12, wherein the translating comprises generating the outbound communication as multiple transmissions, each to a different endpoint and at least two of the multiple transmissions using different radio frequencies.

16. The method of claim 12, further comprising selecting among cellular radio frequencies based on power resources of the wireless access point.

17. The method of claim 12, further comprising receiving an update to the translation logic of the wireless access point, the update supporting translation to and from an additional protocol.

18. A non-transitory computer storage medium having stored thereon a plurality of programming instructions that, when executed by a wireless access point, cause the wireless access point to perform operations comprising:
receiving an inbound communication associated with a first protocol of one of a cellular radio frequency technology or a Wi-Fi radio frequency technology;
translating, by translation logic of the wireless access point, between the first protocol and a second protocol of the other of the cellular radio frequency technology or the Wi-Fi radio frequency technology to generate an outbound communication associated with the second protocol; and
transmitting the outbound communication,
wherein the inbound communication is received at a first part of the wireless access point and the outbound communication is transmitted at a second part of the wireless access point, and one of the first part and the second part is disposed outside of a building and the other of the first part and the second part is disposed inside of the building, on an opposite side of a window of the building from the first part.

19. The non-transitory computer storage medium of claim 18, wherein the first protocol or the second protocol is associated with the cellular radio frequency technology and is one of a new radio (NR) protocol, a long term volution (LTE) protocol, a third generation (3G) protocol, a second generation (2G) protocol, or a protocol associated with citizen broadband radio service (CBRS).

20. The non-transitory computer storage medium of claim 18, wherein the translating comprises generating the outbound communication as multiple transmissions, each to a different endpoint and at least two of the multiple transmissions using different radio frequencies.
